(19) United States
(12) Patent Application Publication
(10) Pub. No.: US 2009/0062982 A1
(43) Pub. Date: Mar. 5, 2009

(54) Apparatus And Method For Controlling In-Vehicle Equipment

(76) Inventors: Kijuro Obata, Iwaki-city (JP); Yasunari Takayama, Iwaki-city (JP)

Correspondence Address: ALPINE/BHGL, P.O. Box 10395, Chicago, IL, 60610, US

(21) Appl. No.: 12/175,103

(22) Filed: Jul. 17, 2008

(30) Foreign Application Priority Data
Aug. 27, 2007 (JP) 2007-219283

(51) Int. Cl. G06F 19/00

(52) U.S. Cl. 701/36

(57) ABSTRACT

In an in-vehicle equipment control apparatus that includes a vehicle status detection unit, a plurality of steering switches for performing an operation on controlled in-vehicle equipment, and a memory, when an operational instruction given via the plurality of steering switches is detected, a signal corresponding to the operational instruction is output to the in-vehicle equipment, and the operational instruction is stored in the memory. Subsequently, when an operational instruction given via one of the plurality of steering switches is detected, it is determined, on the basis of information from the vehicle status detection unit, whether a vehicle is being steered. When it is determined that the vehicle is being steered, a signal corresponding to an operational instruction that has been stored just before in the memory is output to the in-vehicle equipment.

### BACKGROUND OF THE INVENTION

1. Related Application

The present application claims priority to Japanese Patent Application Number 2007-219283, filed Aug. 27, 2007, the entirety of which is hereby incorporated by reference.

2. Field of Invention

The present invention relates to apparatuses and methods for controlling in-vehicle equipment, and in particular relates to an apparatus and a method for controlling in-vehicle equipment that are applied to operating controlled equipment in a vehicle by means of a plurality of controls (for example, switches) provided on a steering wheel.

3. Description of the Related Art

Some switches (controls) for operating in-vehicle audiovisual (AV) units, such as a radio/television receiver and a Compact Disc (CD)/Digital Versatile Disk (DVD) player, in a vehicle are provided on a steering wheel.

Moreover, currently, in some vehicles an adaptive cruise control unit that enables a vehicle to follow a car in front while maintaining a constant distance from the car is provided, and switches for operating the adaptive cruise control unit, together with switches for operating in-vehicle AV units, are provided on a steering wheel. Such a technique is disclosed in, for example, Japanese Unexamined Patent Application Publication No. 2006-327306.

In general, switches for operating in-vehicle equipment, such as an in-vehicle AV unit and an adaptive cruise control unit, are provided on the outside of spokes of a steering wheel so that a driver can readily operate the switches while grasping the steering wheel. Hereinafter, such switches provided on a steering wheel are called steering switches, and a group of such switches is called a steering switch group.

However, when a steering wheel is turned, the positions of steering switches change. Thus, a driver (a user) may erroneously press, instead of a desired steering switch, another steering switch while steering a vehicle. In order not to fail to press a desired steering switch, the switch may be pressed after the position of the switch is visually checked. However, it may be difficult to visually check the position of the switch while a vehicle is driving.

In the technique disclosed in Japanese Unexamined Patent Application Publication No. 2006-327306, in a case where adaptive cruise control is performed, the operation is disabled during a steering operation, even when a steering switch is operated. Such a technique is effective in a case where it is necessary not to change the status set for in-vehicle equipment by operating a steering switch. However, such a technique may be cumbersome when the set status is frequently changed, for example, when a broadcast station is selected or the volume is changed in an in-vehicle AV unit.

### BRIEF SUMMARY

In view of the problems in the known art, it is an object of the present invention to provide an in-vehicle equipment control apparatus and a method for controlling the apparatus in which, while a user is steering a vehicle, the user can readily operate desired in-vehicle equipment without confirming the position of a corresponding steering switch.

To solve the aforementioned problems in the known art, an in-vehicle equipment control apparatus according to a first embodiment of the present invention includes a vehicle status detection device that detects the status of a vehicle, an operation device that includes a plurality of controls that are provided on a steering wheel of the vehicle and are used to perform an operation on controlled equipment provided in the vehicle, a storage device, and a control device that detects an operational instruction via the plurality of controls, outputs a signal corresponding to the operational instruction to the controlled equipment, and stores the operational instruction in the storage device. In a case where the control device detects a first operational instruction via one of the plurality of controls, when the control device determines, on the basis of information from the vehicle status detection device, that the vehicle is being steered, the control device outputs a signal corresponding to an operational instruction that has been stored just before in the storage device to the controlled equipment.

A method according to a second embodiment of the present invention is provided for controlling controlled equipment provided in a vehicle in an in-vehicle equipment control apparatus that includes a vehicle status detection device that detects the status of the vehicle, an operation device that includes a plurality of controls that are provided on a steering wheel of the vehicle and are used to perform an operation on the controlled equipment, and a storage device. The method includes, when an operational instruction via the plurality of controls is detected, outputting a signal corresponding to the operational instruction to the controlled equipment and storing the operational instruction in the storage device; subsequently, when a first operational instruction via one of the plurality of controls is detected, determining, on the basis of information from the vehicle status detection device, whether the vehicle is being steered; and when it is determined that the vehicle is being steered, outputting a signal corresponding to an operational instruction that has been stored just before in the storage device to the controlled equipment.

In the present invention, when an operational instruction via a plurality of controls (for example, steering switches) is detected, a signal corresponding to the operational instruction is output to controlled equipment (for example, in-vehicle equipment, such as a vehicle-surrounding image supply unit and an in-vehicle AV unit), and the operational instruction is stored in a storage device. Subsequently, when an operational instruction via one of the plurality of controls is detected, it is determined whether the vehicle is being steered. When it is determined that the vehicle is being steered, a signal corresponding to an operational instruction that has been stored just before in the storage device is output.

That is to say, in the present invention, in a case where a driver (a user) is steering the vehicle, when any of the plurality of controls has been operated, i.e., when a control that is easiest for the user to operate has been operated, a signal corresponding to an operational instruction that has been stored just before in the storage device is output to the controlled equipment.

Moreover, a control that has been operated just before is repeatedly operated in many cases. For example, when the controlled equipment is a vehicle-surrounding image supply unit that displays, on a screen of a display device, images obtained by a plurality of image pickup devices provided so that images around the vehicle can be obtained, an image changeover switch for switching from an image from one of the image pickup devices that is displayed on the screen of the display device to an image from another one of the image pickup devices may be provided on a steering wheel as a control for performing an operation on the controlled equipment. The user uses such a vehicle-surrounding image supply unit, for example, when moving the vehicle into a parking space. When the user has operated the image changeover switch in the vehicle-surrounding image supply unit, an image obtained by one of the image pickup devices (for example, a camera provided at the rear of the vehicle) provided in a predetermined direction of the vehicle first appears on the screen of the display device (for example, a display unit). Then, while the user is moving the vehicle into a parking space, i.e., the user is steering the vehicle, the user may want to confirm the surrounding status of the vehicle by seeing an image obtained by another one of the image pickup devices (for example, a camera provided at the left of the vehicle).

Thus, in the present invention, when it is determined that the vehicle is being steered, a signal corresponding to an operational instruction via a control that has been operated just before and is repeatedly operated in many cases, i.e., an operational instruction that has been stored in the storage device just before, is output to the controlled equipment.

Accordingly, in the present invention, while the user is steering the vehicle, the user can readily operate desired in-vehicle equipment without confirming the position of a corresponding steering switch.

In the present invention, controlled equipment is not limited to a vehicle-surrounding image supply unit. For example, controlled equipment includes an in-vehicle AV unit, an air conditioner, and a speech recognition unit.

### BRIEF DESCRIPTION OF THE DRAWINGS

FIG. 1 is a block diagram showing the structure of an in-vehicle equipment control apparatus according to an embodiment of the present invention;

FIG. 2 shows the layout of a group of steering switches that constitute an operation unit in FIG. 1;

FIG. 3 is a flowchart showing an exemplary process of control of a vehicle-surrounding image supply unit performed in the in-vehicle equipment control apparatus according to an embodiment of the present invention;

FIG. 4 is a flowchart showing an exemplary process of control of a radio receiver performed in the in-vehicle equipment control apparatus according to an embodiment of the present invention;

FIG. 5 is a flowchart showing an exemplary process of control of an air conditioner performed in the in-vehicle equipment control apparatus according to an embodiment of the present invention; and

FIG. 6 is a flowchart showing an exemplary process of control of a speech recognition unit performed in the in-vehicle equipment control apparatus according to an embodiment of the present invention.

### DETAILED DESCRIPTION OF THE PREFERRED EMBODIMENTS

Embodiments of the present invention will now be described with reference to the attached drawings.

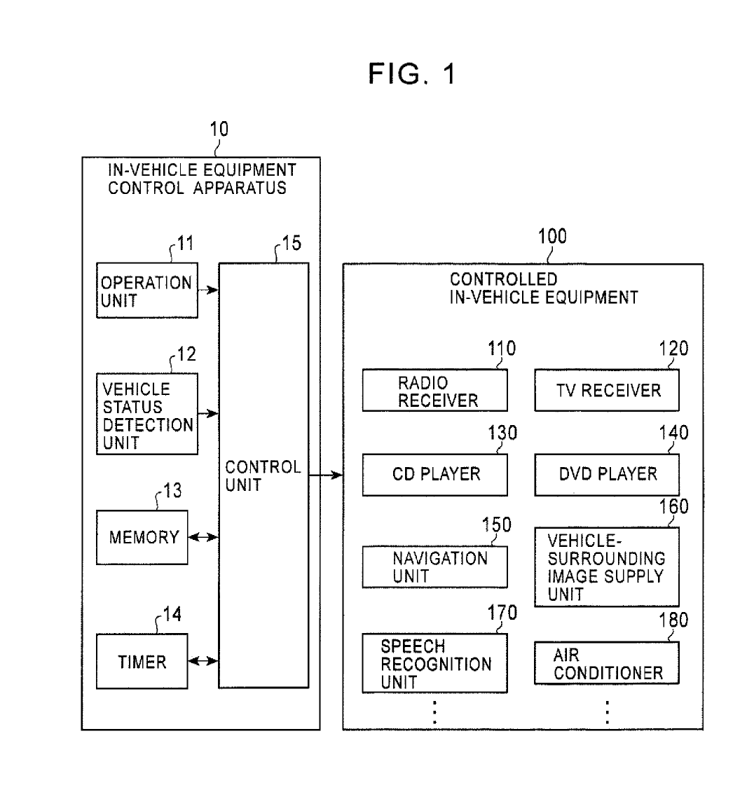

FIG. 1 is a block diagram showing the structure of an in-vehicle equipment control apparatus according to an embodiment of the present invention.

The in-vehicle equipment control apparatus 10 according to the embodiment includes an operation unit 11, a vehicle status detection unit 12, a memory 13, a timer 14, and a control unit 15. The in-vehicle equipment control apparatus 10 is connected to controlled in-vehicle equipment 100 via a bus (not shown), such as an optical fiber, provided as a transmission line. The controlled in-vehicle equipment 100 may include, for example, a radio receiver 110, a television (TV) receiver 120, a CD player 130, a DVD player 140, a navigation unit 150, a vehicle-surrounding image supply unit 160, a speech recognition unit 170, and/or an air conditioner 180.

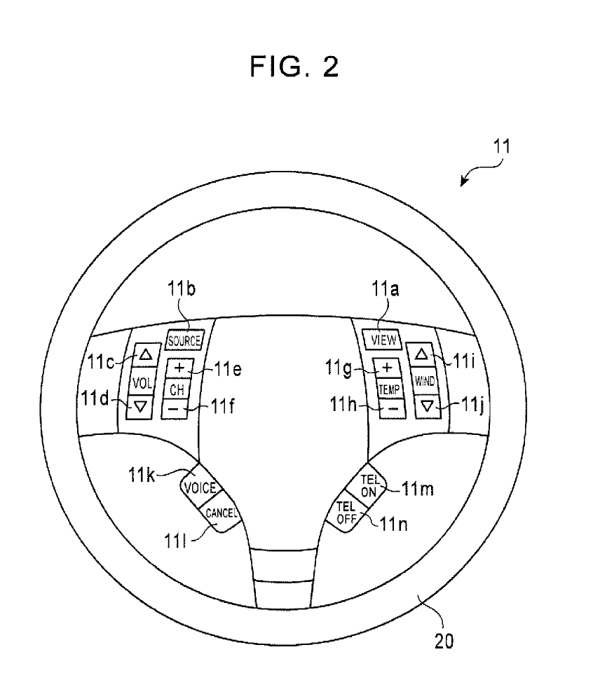

In the in-vehicle equipment control apparatus 10, the operation unit 11 is used to input information indicated by a driver (a user) and includes a plurality of steering switches 11a to 11n provided toward the outside (the area of a part that is grasped by the user's hands) of spokes of a steering wheel 20, as shown in FIG. 2. Hereinafter, a group of the steering switches 11a to 11n is sometimes called a steering switch group.

The switch 11a is an image changeover switch for instructing the vehicle-surrounding image supply unit 160 to switch from a currently displayed camera image to another camera image. The switch 11b is a source changeover switch for giving an instruction to change the in-vehicle AV unit to be operated, for example, the radio receiver 110, the TV receiver 120, the CD player 130, or the DVD player 140. The switch 11c is a volume increase switch for giving an instruction to increase the volume of an operating in-vehicle AV unit by one level. The switch 11d is a volume decrease switch for giving an instruction to decrease the volume of an operating in-vehicle AV unit by one level. When an operating in-vehicle AV unit is the radio receiver 110 or the TV receiver 120, the switch 11e functions as a seek up switch for giving an instruction to switch from a current broadcasting station to the next station, and the switch 11f functions as a seek down switch for giving an instruction to switch from a current broadcasting station to the previous station. When an operating in-vehicle AV unit is the CD player 130 or the DVD player 140, the switch 11e functions as a track (or chapter) up switch for giving an instruction to switch from a track (or chapter) that is currently being played back to the next track (or chapter), and the switch 11f functions as a track (or chapter) down switch for giving an instruction to switch from a track (or chapter) that is currently being played back to the previous track (or chapter).

The switch 11g is a temperature increase switch for instructing the air conditioner 180 to increase a set temperature by one degree. The switch 11h is a temperature decrease switch for instructing the air conditioner 180 to decrease a set temperature by one degree. The switch 11i is an air volume increase switch for instructing the air conditioner 180 to increase a set air volume by one level. The switch 11j is an air volume decrease switch for instructing the air conditioner 180 to decrease a set air volume by one level. The switch 11k is a speech recognition switch for instructing the speech recognition unit 170 to perform speech recognition on speech given by the user. The switch 11l is a cancel switch for giving an instruction to cancel an operational instruction issued via the speech recognition unit 170. The switch 11m is a telephone call switch for giving an instruction to make a telephone call with a cellular phone (not shown) connected to the navigation unit 150 as a communication unit for communicating with a facility (for example, an information communications center) outside the vehicle. The switch 11n is a telephone call termination switch for giving an instruction to terminate a telephone call through the cellular phone (not shown).

The vehicle status detection unit 12 is used to output information of the status in which the vehicle is driving and includes, for example, a steering angle sensor, a shift position sensor, a parking brake sensor, a vehicle speed sensor, a distance sensor, and an accelerator/brake depression stroke sensor. The output information of the vehicle includes, for example, a steering angle corresponding to the amount of rotation by a steering operation, individual shift positions (in the case of an automatic transmission (AT) vehicle, D (drive), N (neutral), R (rear), and P (parking)), a signal that indicates whether the parking brake is applied, the travel speed of the vehicle, and an engine start/stop signal based on the on-off operation of an ignition key.

The memory 13 includes, for example, a dynamic random access memory (DRAM) and is used to store necessary information under the control of the control unit 15. The timer 14 is used to measure time under the control of the control unit 15. In the present embodiment, the memory 13 and the timer 14 are separate from the control unit 15. Alternatively, the memory 13 and the timer 14 may be provided in the control unit 15.

The control unit 15 includes, for example, a microcomputer and is used to control the in-vehicle equipment control apparatus 10 and the controlled in-vehicle equipment 100. Generally, the control unit 15 detects an operational instruction via the steering switches 11a to 11n and outputs a control signal corresponding to the operational instruction to the in-vehicle equipment 100 subjected to control. The control unit 15 stores an operational instruction via the steering switches 11a to 11n in the memory 13 upon detecting the operational instruction. The control unit 15 starts the timer 14 upon detecting an operational instruction and determines whether a predetermined time has elapsed after detecting the operational instruction. Upon detecting an operational instruction, the control unit 15 determines, on the basis of information from the vehicle status detection unit 12, whether the vehicle is being steered. When the control unit 15 determines that the vehicle is being steered, the control unit 15 outputs a control signal corresponding to the operational instruction stored in the memory 13 to the in-vehicle equipment 100 subjected to control. When the control unit 15 determines that the vehicle is not being steered, the control unit 15 outputs a control signal corresponding to a detected operational instruction to the in-vehicle equipment 100 subjected to control. When the control unit 15 determines that the vehicle is not being steered, the control unit 15 does not store the detected operational instruction in the memory 13.

In the in-vehicle equipment control apparatus 10, the operation unit 11 corresponds to an operation device, the steering switches 11a to 11n correspond to controls, the memory 13 corresponds to a storage device, and the control unit 15 corresponds to a control device.

Processes of control of the controlled in-vehicle equipment 100 performed in the in-vehicle equipment control apparatus 10 according to the present embodiment will now be described specifically. In the present embodiment, exemplary processes will be described, in each of which the controlled in-vehicle equipment 100 is one of the vehicle-surrounding image supply unit 160, the radio receiver 110, the air conditioner 180, and the speech recognition unit 170.

### First Exemplary Process

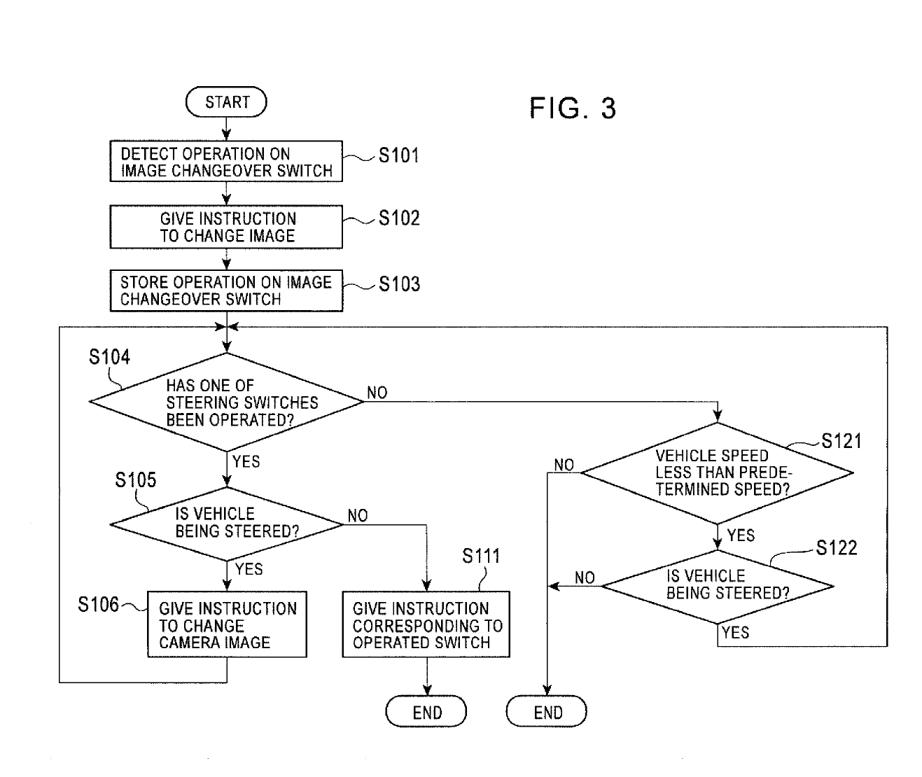

In a first exemplary process, a process of control of the vehicle-surrounding image supply unit 160 performed in the in-vehicle equipment control apparatus 10 will be described with reference to FIG. 3 showing an exemplary process flow.

In this case, it is assumed that the vehicle-surrounding image supply unit 160 includes, for example, four in-vehicle cameras (image pickup devices) provided at the front, rear, right, and left of the vehicle to capture images around the vehicle, an image processing unit that appropriately performs image processing on the images captured by the individual in-vehicle cameras, a display unit (a display device) that displays the camera images processed by the image processing unit, and a controller that controls these components. Moreover, it is assumed that vehicle status detection signals are input to the controller in the vehicle-surrounding image supply unit 160 from the aforementioned sensors of the vehicle.

It is also assumed that the engine of the vehicle is operating, and thus the vehicle-surrounding image supply unit 160 is ready to operate. In this case, it is assumed that no camera image is displayed on the screen of the display unit even though the display unit is ready to display images. Moreover, it is assumed that the user is backing the vehicle into a parking space.

In FIG. 3, when the user has pressed the image changeover switch 11a out of the steering switches 11a to 11n, in step S101, the control unit 15 in the in-vehicle equipment control apparatus 10 detects that the image changeover switch 11a has been operated. When the control unit 15 detects that the image changeover switch 11a has been operated (an operational instruction), the control unit 15 turns on a camera image changeover mode, and the process proceeds to step S102.

In step S102, in response to the operational instruction given via the image changeover switch 11a, the control unit 15 outputs a control signal for giving an instruction to change the camera image to the vehicle-surrounding image supply unit 160. When the control signal has been input to the vehicle-surrounding image supply unit 160, the controller in the vehicle-surrounding image supply unit 160 checks the status (the shift position, in this case, R) of the vehicle on the basis of the vehicle status detection signals and activates the in-vehicle camera provided at the rear of the vehicle. An image of the area behind the vehicle appears on the display unit in the vehicle-surrounding image supply unit 160 by this operation. Then, in step S103, the control unit 15 stores the operational instruction given via the image changeover switch 11a in the memory 13. Then, the process proceeds to step S104.

In step S104, the control unit 15 determines whether one of the steering switches 11a to 11n has been operated. When the control unit 15 determines that one of the steering switches 11a to 11n has been operated, the process proceeds to step S105. Otherwise, the process proceeds to step S121.

When the control unit 15 determines that one of the steering switches 11a to 11n has been operated, in step S105, the control unit 15 determines, on the basis of information from the vehicle status detection unit 12, whether the vehicle is being steered. In this case, when relevant criteria are met, i.e., when the steering angle detected by the steering angle sensor is equal to or more than a predetermined angle (for example, in a case where the direction of a steering operation is clockwise or counterclockwise, when the steering angle is equal to or more than thirty degrees with respect to a reference position) and when the shift position detected by the shift position sensor is other than P and N in the case of an AT vehicle (or when the status of the parking brake detected by the parking brake sensor is that in which the parking brake is not applied in the case of a manual transmission (MT) vehicle), the control unit 15 determines that the vehicle is being steered. When the control unit 15 determines that the vehicle is being steered, the process proceeds to step S106. Otherwise, the process proceeds to step S111.

When the control unit 15 determines that the vehicle is being steered, in step S106, the control unit 15 outputs, to the vehicle-surrounding image supply unit 160, a control signal corresponding to the operational instruction stored in the memory 13, i.e., the operational instruction given via the image changeover switch 11a, instead of an operational instruction given via the actually operated steering switch. When the control signal has been input to the vehicle-surrounding image supply unit 160, the controller in the vehicle-surrounding image supply unit 160 turns off the in-vehicle camera provided at the rear of the vehicle and activates another in-vehicle camera, for example, the in-vehicle camera provided at the left of the vehicle. An image on the left side of the vehicle, instead of the image behind the vehicle, appears on the display unit in the vehicle-surrounding image supply unit 160 by this operation. In step S106, the control unit 15 does not store the operational instruction given via the actually operated steering switch in the memory 13 and keeps the status of the memory 13 in which the operational instruction given via the image changeover switch 11a is stored. When the control unit 15 determines, in this manner, that the vehicle is being steered, the camera image changeover mode is maintained. Then, the process returns to step S104.

On the other hand, when the control unit 15 determines that the vehicle is not being steered, in step S111, the control unit 15 outputs, to the in-vehicle equipment 100 subjected to control, a control signal corresponding to the operational instruction given via the actually operated steering switch. That is to say, the control unit 15 performs a normal control operation. In response to this operation, the control unit 15 turns off the camera image changeover mode and turns on a mode corresponding to the operational instruction given via the actually operated steering switch. Then, the process is completed.

When the control unit 15 determines in step S104 that none of the steering switches 11a to 11n has been operated, in step S121, the control unit 15 determines, on the basis of the information from the vehicle status detection unit 12, whether the speed of the vehicle is equal to or less than a predetermined speed (for example, 20 km/h). When the control unit 15 determines that the speed of the vehicle is equal to or less than the predetermined speed, the control unit 15 determines that the vehicle is still being parked, and thus changeover of the camera image is necessary, and the process proceeds to step S122. Otherwise, the control unit 15 determines that the vehicle is moving not for parking but normal driving, and thus changeover of the camera image is no longer necessary. Thus, the control unit 15 turns off the camera image changeover mode, and the process is completed.

When the control unit 15 determines that the speed of the vehicle is equal to or less than the predetermined speed, in step S122, the control unit 15 determines, on the same criteria as in step S105, whether the vehicle is being steered. When the control unit 15 determines that the vehicle is being steered, the control unit 15 determines that the vehicle is still being parked, and thus changeover of the camera image is necessary, and the process returns to step S104. Otherwise, the control unit 15 determines that parking of the vehicle is completed, and thus changeover of the camera image is no longer necessary. Thus, the control unit 15 turns off the camera image changeover mode, and the process is completed.

In the in-vehicle equipment control apparatus 10 according to the present embodiment, when an operational instruction via a steering switch (the image changeover switch 11a) has been detected, a control signal corresponding to the operational instruction is output to in-vehicle equipment subjected to control (the vehicle-surrounding image supply unit 160), and the operational instruction is stored in the memory 13. Subsequently, when an operational instruction given via one of the steering switches 11a to 11n has been detected, it is determined whether the vehicle is being steered. In a case where it is determined that the vehicle is being steered, a control signal corresponding to the operational instruction, which has been stored in the memory 13 just before, is output. In other words, in a case where it is determined that the vehicle is being steered, even when any of the other steering switches 11a to 11n has been operated, i.e., when a steering switch that is easiest for the user to operate has been operated, a control signal corresponding to the operational instruction given via the steering switch which has been operated just before, i.e., the operational instruction (in this exemplary process, the operational instruction given via the image changeover switch 11a) which has been stored in the memory 13 just before, is output.

Thus, while the user is steering the vehicle, the user can readily operate desired in-vehicle equipment without confirming the position of a corresponding steering switch.

In the foregoing exemplary process, a case where the user backs the vehicle into a parking space has been described. However, the user may move the vehicle forward into a parking space. In this case, in step S102, the control unit 15 outputs a control signal corresponding to an operational instruction given via the image changeover switch 11a to the vehicle-surrounding image supply unit 160 to display an image in front of the vehicle on the display unit in the vehicle-surrounding image supply unit 160.

### Second Exemplary Process

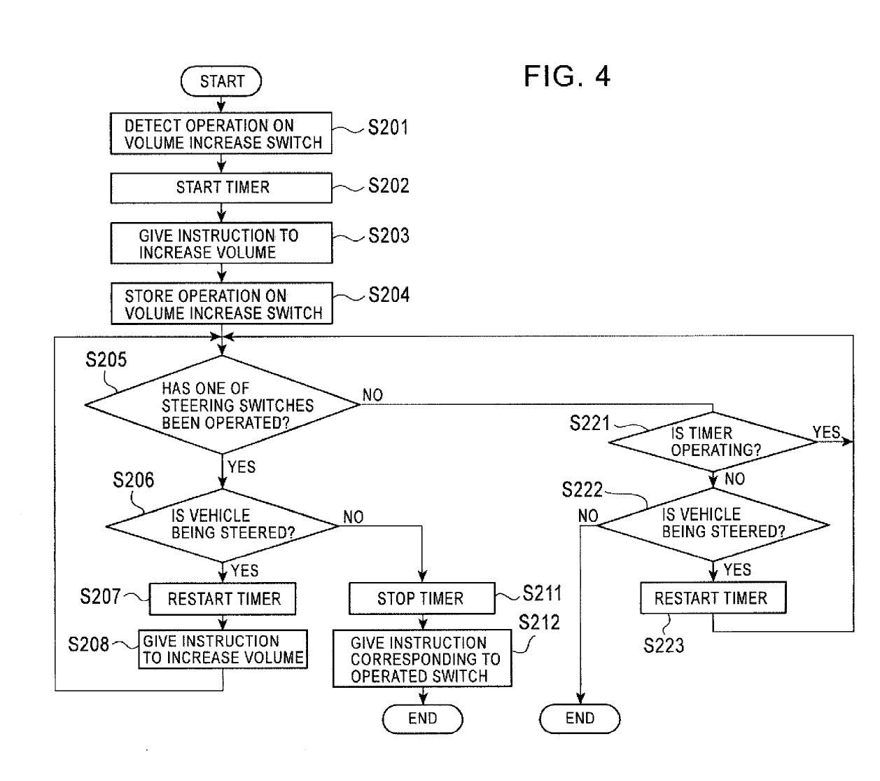

In a second exemplary process, a process of control of the radio receiver 110 performed in the in-vehicle equipment control apparatus 10 will be described with reference to FIG. 4 showing an exemplary process flow. It is assumed that the engine of the vehicle is operating, only the radio receiver 110 out of the in-vehicle AV units is operating, and sounds of a program of a station received by the radio receiver 110 are being output through a speaker provided in the vehicle.

In FIG. 4, when the user has pressed the volume increase switch 11c out of the steering switches 11a to 11n, in step S201, the control unit 15 in the in-vehicle equipment control apparatus 10 detects that the volume increase switch 11c has been operated. When the control unit 15 detects that the volume increase switch 11c has been operated (an operational instruction), the control unit 15 turns on a volume increase continuation mode, and the process proceeds to step S202.

In step S202, the control unit 15 starts the timer 14. Then, in step S203, in response to the operational instruction given via the volume increase switch 11c, the control unit 15 outputs a control signal for giving an instruction to increase the volume by one level to the radio receiver 110. When the control signal has been input to the operating radio receiver 110, the radio receiver 110 increases the volume of the sounds of the program of the station, which is being received, by one level and outputs the sounds from the speaker. The operating time of the timer 14 is, for example, three seconds. Then, in step S204, the control unit 15 stores the operational instruction given via the volume increase switch 11c in the memory 13. Then, the process proceeds to step S205.

In step S205, the control unit 15 determines whether one of the steering switches 11a to 11n has been operated. When the control unit 15 determines that one of the steering switches 11a to 11n has been operated, the process proceeds to step S206. Otherwise, the process proceeds to step S221.

When the control unit 15 determines that one of the steering switches 11a to 11n has been operated, in step S206, the control unit 15 determines, on the basis of information from the vehicle status detection unit 12, whether the vehicle is being steered. In this case, the control unit 15 determines, on the same criteria as in step S105 in the first exemplary process, whether the vehicle is being steered. When the control unit 15 determines that the vehicle is being steered, the process proceeds to step S207. Otherwise, the process proceeds to step S211.

When the control unit 15 determines that the vehicle is being steered, in step S207, the control unit 15 restarts the timer 14. Then, in step S208, the control unit 15 outputs, to the radio receiver 110, a control signal corresponding to the operational instruction stored in the memory 13, i.e., the operational instruction given via the volume increase switch 11c, instead of an operational instruction given via the actually operated steering switch. When the control signal has been input to the operating radio receiver 110, the radio receiver 110 increases the volume of the sounds of the program of the station, which is being received, by one level and outputs the sounds from the speaker. In steps S207 and S208, the control unit 15 does not store the operational instruction given via the actually operated steering switch in the memory 13 and keeps the status of the memory 13 in which the operational instruction given via the volume increase switch 11c is stored. When the control unit 15 determines, in this manner, that the vehicle is being steered, the volume increase continuation mode is maintained. Then, the process returns to step S205.

On the other hand, when the control unit 15 determines that the vehicle is not being steered, in step S211, the control unit 15 stops the timer 14. Then, in step S212, the control unit 15 outputs, to the in-vehicle equipment 100 subjected to control, a control signal corresponding to the operational instruction given via the actually operated steering switch. That is to say, the control unit 15 performs a normal control operation. In response to this operation, the control unit 15 turns off the volume increase continuation mode and turns on a mode corresponding to the operational instruction given via the actually operated steering switch. Then, the process is completed.

When the control unit 15 determines in step S205 that none of the steering switches 11a to 11n has been operated, in step S221, the control unit 15 determines whether the timer 14 is operating. When the control unit 15 determines that the timer 14 is operating, the process returns to step S205. Otherwise, when the operating time of the timer 14 has elapsed, the process proceeds to step S222 where it is determined whether the volume needs to be continuously increased.

In step S222, the control unit 15 determines, on the same criteria as in step S206, whether the vehicle is being steered. When the control unit 15 determines that the vehicle is being steered, the control unit 15 determines that the volume needs to be continuously increased, and the process proceeds to step S223. In step S223, the control unit 15 restarts the timer 14, and the process returns to step S205. That is to say, the volume increase continuation mode is maintained. When the control unit 15 determines that the vehicle is not being steered, the control unit 15 determines that the volume need not be continuously increased. Thus, the control unit 15 turns off the volume increase continuation mode, and the process is completed.

In the in-vehicle equipment control apparatus 10 according to the present embodiment, in a case where it is determined that the vehicle is being steered, even when any of the steering switches 11a to 11n has been operated, a control signal corresponding to an operational instruction given via a steering switch (in this exemplary process, an operational instruction given via the volume increase switch 11c) that has been operated just before is output. Thus, while the user is steering the vehicle, the user can readily operate desired in-vehicle equipment without confirming the position of a corresponding steering switch.

In the foregoing exemplary process, the control unit 15 turns on the volume increase continuation mode upon detecting in step S201 that the volume increase switch 11c has been operated. However, in step S201, the control unit 15 turns on a volume decrease continuation mode upon detecting that the volume decrease switch 11d has been operated, turns on a seek up continuation mode upon detecting that the seek up switch 11e has been operated, and turns on a seek down continuation mode upon detecting that the seek down switch 11f has been operated. Then, a process similar to the aforementioned process is performed.

Moreover, while a process of control of the radio receiver 110 performed in the in-vehicle equipment control apparatus 10 has been described in the aforementioned exemplary process, a process similar to the aforementioned process may be performed for another in-vehicle AV unit (the TV receiver 120, the CD player 130, or the DVD player 140).

Moreover, while a process of control of functions of a specific in-vehicle AV unit has been described in the aforementioned exemplary process, the embodiment is not limited to this process. For example, when the control unit 15 detects in step S201 that the source changeover switch 11b has been operated, the control unit 15 turns on a source changeover mode and outputs, in response to the operational instruction given via the switch 11b, a control signal for giving an instruction to switch from an operating in-vehicle AV unit (for example, the radio receiver 110) to another in-vehicle AV unit (for example, the TV receiver 120).

### Third Exemplary Process

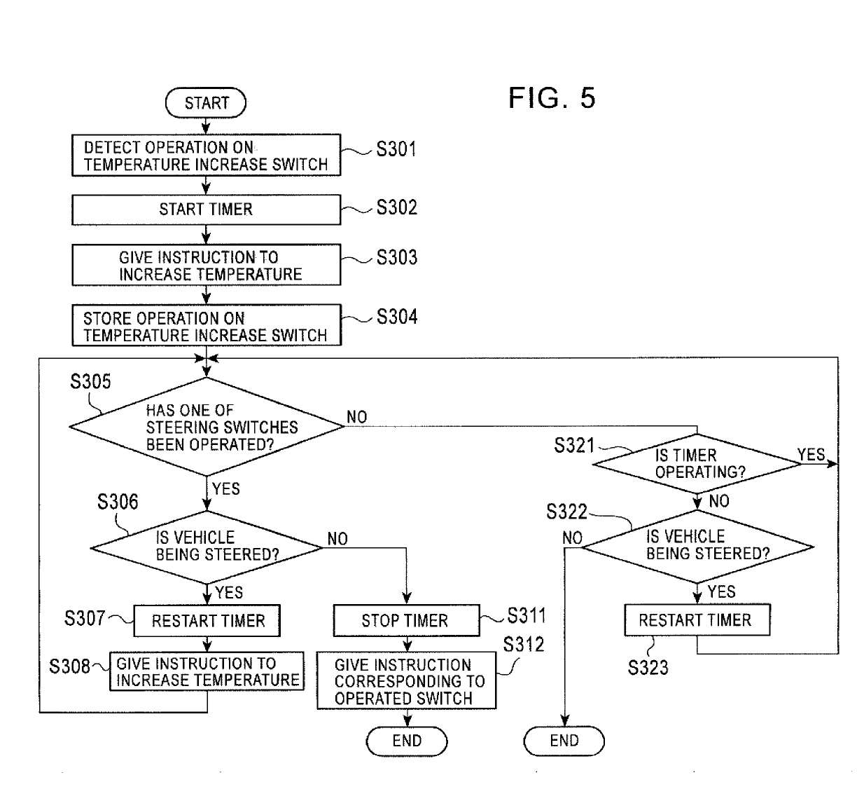

In a third exemplary process, a process of control of the air conditioner 180 performed in the in-vehicle equipment control apparatus 10 will be described with reference to FIG. 5 showing an exemplary process flow. It is assumed that the engine of the vehicle and the air conditioner 180 are operating.

In FIG. 5, when the user has pressed the temperature increase switch 11g out of the steering switches 11a to 11n, in step S301, the control unit 15 in the in-vehicle equipment control apparatus 10 detects that the temperature increase switch 11g has been operated. When the control unit 15 detects that the temperature increase switch 11g has been operated (an operational instruction), the control unit 15 turns on a temperature increase continuation mode, and the process proceeds to step S302.

In step S302, the control unit 15 starts the timer 14. Then, in step S303, in response to the operational instruction given via the temperature increase switch 11g, the control unit 15 outputs a control signal for giving an instruction to increase the temperature by one degree to the air conditioner 180. When the control signal has been input to the air conditioner 180, the air conditioner 180 increases the set temperature by one degree. The operating time of the timer 14 is, for example, three seconds. Then, in step S304, the control unit 15 stores the operational instruction given via the temperature increase switch 11g in the memory 13. Then, the process proceeds to step S305.

In step S305, the control unit 15 determines whether one of the steering switches 11a to 11n has been operated. When the control unit 15 determines that one of the steering switches 11a to 11n has been operated, the process proceeds to step S306. Otherwise, the process proceeds to step S321.

When the control unit 15 determines that one of the steering switches 11a to 11n has been operated, in step S306, the control unit 15 determines, on the basis of information from the vehicle status detection unit 12, whether the vehicle is being steered. In this case, the control unit 15 determines, on the same criteria as in step S105 in the first exemplary process, whether the vehicle is being steered. When the control unit 15 determines that the vehicle is being steered, the process proceeds to step S307. Otherwise, the process proceeds to step S311.

When the control unit 15 determines that the vehicle is being steered, in step S307, the control unit 15 restarts the timer 14. Then, in step S308, the control unit 15 outputs, to the air conditioner 180, a control signal corresponding to the operational instruction stored in the memory 13, i.e., the operational instruction given via the temperature increase switch 11g, instead of an operational instruction given via the actually operated steering switch. When the control signal has been input to the air conditioner 180, the air conditioner 180 increases the set temperature by one degree. In steps S307 and S308, the control unit 15 does not store the operational instruction given via the actually operated steering switch in the memory 13 and keeps the status of the memory 13 in which the operational instruction given via the temperature increase switch 11g is stored. When the control unit 15 determines, in this manner, that the vehicle is being steered, the temperature increase continuation mode is maintained. Then, the process returns to step S305.

On the other hand, when the control unit 15 determines that the vehicle is not being steered, in step S311, the control unit 15 stops the timer 14. Then, in step S312, the control unit 15 outputs, to the in-vehicle equipment 100 subjected to control, a control signal corresponding to the operational instruction given via the actually operated steering switch. That is to say, the control unit 15 performs a normal control operation. In response to this operation, the control unit 15 turns off the temperature increase continuation mode and turns on a mode corresponding to the operational instruction given via the actually operated steering switch. Then, the process is completed.

When the control unit 15 determines in step S305 that none of the steering switches 11a to 11n has been operated, in step S321, the control unit 15 determines whether the timer 14 is operating. When the control unit 15 determines that the timer 14 is operating, the process returns to step S305. Otherwise, when the operating time of the timer 14 has elapsed, the process proceeds to step S322 where it is determined whether the temperature needs to be continuously increased.

In step S322, the control unit 15 determines, on the same criteria as in step S306, whether the vehicle is being steered. When the control unit 15 determines that the vehicle is being steered, the control unit 15 determines that the temperature needs to be continuously increased, and the process proceeds to step S323. In step S323, the control unit 15 restarts the timer 14, and the process returns to step S305. That is to say, the temperature increase continuation mode is maintained. When the control unit 15 determines that the vehicle is not being steered, the control unit 15 determines that the temperature need not be continuously increased. Thus, the control unit 15 turns off the temperature increase continuation mode, and the process is completed.

In the in-vehicle equipment control apparatus 10 according to the present embodiment, in a case where it is determined that the vehicle is being steered, when any of the steering switches 11a to 11n has been operated, a control signal corresponding to an operational instruction given via a steering switch that has been operated just before (in this exemplary process, an operational instruction given via the temperature increase switch 11g) is output. Thus, while the user is steering the vehicle, the user can readily operate desired in-vehicle equipment without confirming the position of a corresponding steering switch.

In the foregoing exemplary process, the control unit 15 turns on the temperature increase continuation mode upon detecting in step S301 that the temperature increase switch 11g has been operated. However, in step S301, the control unit 15 turns on a temperature decrease continuation mode upon detecting that the temperature decrease switch 11h has been operated, turns on an air volume increase continuation mode upon detecting that the air volume increase switch 11i has been operated, and turns on an air volume decrease continuation mode upon detecting that the air volume decrease switch 11j has been operated. Then, a process similar to the aforementioned process is performed.

### Fourth Exemplary Process

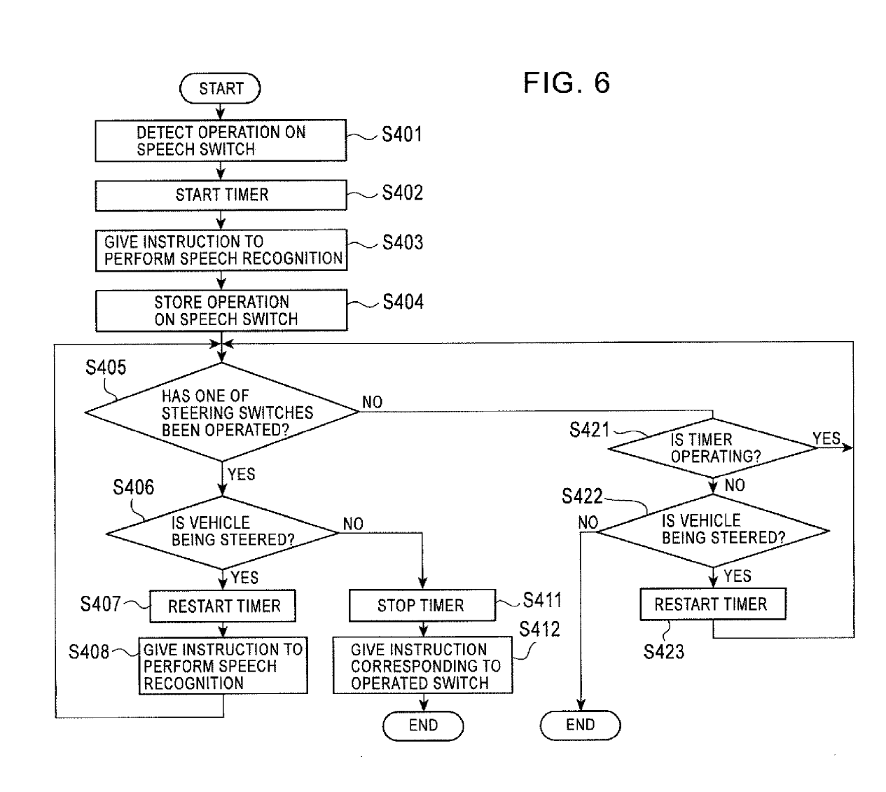

In a fourth exemplary process, a process of control of the speech recognition unit 170 performed in the in-vehicle equipment control apparatus 10 will be described with reference to FIG. 6 showing an exemplary process flow.

It is assumed that the speech recognition unit 170 is connected to the other controlled in-vehicle equipment 100 (for example, the radio receiver 110, the TV receiver 120, the CD player 130, the DVD player 140, the navigation unit 150, the vehicle-surrounding image supply unit 160, and/or the air conditioner 180) via the bus, and includes, for example, a controller that performs speech recognition on speech by the user that is input through a microphone (a speech input device) provided in the vehicle and outputs a control signal corresponding to the speech to the other controlled in-vehicle equipment 100.

Moreover, it is assumed that the engine of the vehicle is operating, and thus the speech recognition unit 170 is ready to operate.

In FIG. 6, when the user has pressed the speech recognition switch 11k out of the steering switches 11a to 11n, in step S401, the control unit 15 in the in-vehicle equipment control apparatus 10 detects that the speech recognition switch 11k has been operated. When the control unit 15 detects that the speech recognition switch 11k has been operated (an operational instruction), the control unit 15 turns on a speech recognition continuation mode, and the process proceeds to step S402.

In step S402, the control unit 15 starts the timer 14. Then, in step S403, in response to the operational instruction given via the speech recognition switch 11k, the control unit 15 outputs a control signal for giving an instruction to perform speech recognition on speech by the user to the speech recognition unit 170. When the control signal has been input to the speech recognition unit 170, the controller in the speech recognition unit 170 performs speech recognition on speech by the user and outputs a control signal corresponding to the speech to the other controlled in-vehicle equipment 100. For example, when the speech by the user is “details”, the speech recognition unit 170 outputs a control signal for giving an instruction to display a detailed map to the navigation unit 150. The operating time of the timer 14 is, for example, ten seconds. Then, in step S404, the control unit 15 stores the operational instruction given via the speech recognition switch 11k in the memory 13. Then, the process proceeds to step S405.

In step S405, the control unit 15 determines whether one of the steering switches 11a to 11n has been operated. When the control unit 15 determines that one of the steering switches 11a to 11n has been operated, the process proceeds to step S406. Otherwise, the process proceeds to step S421.

When the control unit 15 determines that one of the steering switches 11a to 11n has been operated, in step S406, the control unit 15 determines, on the basis of information from the vehicle status detection unit 12, whether the vehicle is being steered. In this case, the control unit 15 determines, on the same criteria as in step S105 in the first exemplary process, whether the vehicle is being steered. When the control unit 15 determines that the vehicle is being steered, the process proceeds to step S407. Otherwise, the process proceeds to step S411.

When the control unit 15 determines that the vehicle is being steered, in step S407, the control unit 15 restarts the timer 14. Then, in step S408, the control unit 15 outputs, to the speech recognition unit 170, a control signal corresponding to the operational instruction stored in the memory 13, i.e., the operational instruction given via the speech recognition switch 11k, instead of an operational instruction given via the actually operated steering switch. When the control signal has been input to the speech recognition unit 170, the controller in the speech recognition unit 170 performs speech recognition on speech by the user and outputs a control signal corresponding to the speech to the other controlled in-vehicle equipment 100. For example, when the speech by the user is “parking lot”, the speech recognition unit 170 outputs a control signal for giving an instruction to the navigation unit 150 to display landmarks showing parking lots on a map. In steps S407 and S408, the control unit 15 does not store the operational instruction given via the actually operated steering switch in the memory 13 and keeps the status of the memory 13 in which the operational instruction given via the speech recognition switch 11k is stored. When the control unit 15 determines, in this manner, that the vehicle is being steered, the speech recognition continuation mode is maintained. Then, the process returns to step S405.

On the other hand, when the control unit 15 determines that the vehicle is not being steered, in step S411, the control unit 15 stops the timer 14. Then, in step S412, the control unit 15 outputs, to the in-vehicle equipment 100 subjected to control, a control signal corresponding to the operational instruction given via the actually operated steering switch. That is to say, the control unit 15 performs a normal control operation. In response to this operation, the control unit 15 turns off the speech recognition continuation mode and turns on a mode corresponding to the operational instruction given via the actually operated steering switch. Then, the process is completed.

When the control unit 15 determines in step S405 that none of the steering switches 11a to 11n has been operated, in step S421, the control unit 15 determines whether the timer 14 is operating. When the control unit 15 determines that the timer 14 is operating, the process returns to step S405. Otherwise, when the operating time of the timer 14 has elapsed, the process proceeds to step S422 where it is determined whether speech recognition needs to be continuously performed.

In step S422, the control unit 15 determines, on the same criteria as in step S406, whether the vehicle is being steered. When the control unit 15 determines that the vehicle is being steered, the control unit 15 determines that speech recognition needs to be continuously performed, and the process proceeds to step S423. In step S423, the control unit 15 restarts the timer 14, and the process returns to step S405. That is to say, the speech recognition continuation mode is maintained. When the control unit 15 determines that the vehicle is not being steered, the control unit 15 determines that speech recognition need not be continuously performed. Thus, the control unit 15 turns off the speech recognition continuation mode, and the process is completed.

In the in-vehicle equipment control apparatus 10 according to the present embodiment, in a case where it is determined that the vehicle is being steered, when any of the steering switches 11a to 11n has been operated, a control signal corresponding to an operational instruction given via a steering switch that has been operated just before (in this exemplary process, an operational instruction given via the speech recognition switch 11k) is output. Thus, while the user is steering the vehicle, the user can readily operate desired in-vehicle equipment without confirming the position of a corresponding steering switch.

While a case where the object controlled by the speech recognition unit 170 is the navigation unit 150 has been described in the aforementioned exemplary process, the object controlled by the speech recognition unit 170 is not limited to the navigation unit 150. The object controlled by the speech recognition unit 170 may include other controlled in-vehicle equipment 100 connected to the speech recognition unit 170.

While cases where the controlled in-vehicle equipment 100 includes the radio receiver 110, the TV receiver 120, the CD player 130, the DVD player 140, the navigation unit 150, the vehicle-surrounding image supply unit 160, the speech recognition unit 170, and the air conditioner 180 have been described in the aforementioned embodiments, the controlled in-vehicle equipment 100 is not limited to these components. The controlled in-vehicle equipment 100 may include other in-vehicle units (for example, an adaptive cruise control unit).

While there has been illustrated and described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teachings of the invention without departing from the central scope thereof. Therefore, it is intended that this invention not be limited to the particular embodiments disclosed, but that the invention will include all embodiments falling within the scope of the appended claims.

1. An in-vehicle equipment control apparatus comprising:
a vehicle status detection device that detects the status of a vehicle;
an operation device that includes a plurality of controls that are provided on a steering wheel of the vehicle and are used to perform an operation on controlled equipment provided in the vehicle;
a storage device; and
a control device that detects an operational instruction given via the plurality of controls, outputs a signal corresponding to the operational instruction to the controlled equipment, and stores the operational instruction in the storage device,
wherein, in a case where the control device detects a first operational instruction given via one of the plurality of controls, when the control device determines, on the basis of information from the vehicle status detection device, that the vehicle is being steered, the control device outputs a signal corresponding to an operational instruction that has been stored just before in the storage device to the controlled equipment.

2. The in-vehicle equipment control apparatus according to claim 1, wherein, when the control device determines that the vehicle is being steered, the control device does not store the first operational instruction in the storage device.

3. The in-vehicle equipment control apparatus according to claim 1, wherein, in a case where the control device detects the first operational instruction given via the one of the plurality of controls, when the control device determines, on the basis of information from the vehicle status detection device, that the vehicle is not being steered, the control device outputs a signal corresponding to the first operational instruction to the controlled equipment.

4. The in-vehicle equipment control apparatus according to claim 1, wherein the vehicle status detection device includes a steering angle sensor that detects a steering angle of the steering wheel and a shift position sensor that detects a position of a shift of the vehicle, and
when the steering angle of the steering wheel detected by the steering angle sensor is equal to or more than a predetermined angle and when the position of the shift of the vehicle detected by the shift position sensor is other than parking and neutral, the control device determines that the vehicle is being steered.

5. The in-vehicle equipment control apparatus according to claim 1, wherein the vehicle status detection device includes a steering angle sensor that detects a steering angle of the steering wheel and a parking brake sensor that detects whether a parking brake of the vehicle is applied, and
when the steering angle of the steering wheel detected by the steering angle sensor is equal to or more than a predetermined angle and when the status of the parking brake of the vehicle detected by the parking brake sensor is that in which the parking brake is not applied, the control device determines that the vehicle is being steered.

6. The in-vehicle equipment control apparatus according to claim 1, wherein the controlled equipment includes a vehicle-surrounding image supply unit that displays, on a screen of a display device, images obtained by a plurality of image pickup devices provided so that images around the vehicle can be obtained, and
the plurality of controls includes an image changeover switch for switching from an image from one of the image pickup devices that is displayed on the screen of the display device to an image from another one of the image pickup devices.

7. The in-vehicle equipment control apparatus according to claim 1, wherein the controlled equipment includes a radio receiver, and
the plurality of controls includes at least one of a station changeover switch for switching from a station that is being received by the radio receiver to another station and a volume changeover switch for changing the volume of a broadcast that is being received by the radio receiver.

8. The in-vehicle equipment control apparatus according to claim 1, wherein the controlled equipment includes a television receiver, and
the plurality of controls includes at least one of a station changeover switch for switching from a station that is being received by the television receiver to another station and a volume changeover switch for changing the volume of a broadcast that is being received by the television receiver.

9. The in-vehicle equipment control apparatus according to claim 1, wherein the controlled equipment includes a CD player, and
the plurality of controls includes at least one of a track changeover switch for switching from a track of a CD that is being played back by the CD player to another track and a volume changeover switch for changing the volume of a track that is being played back by the CD player.

10. The in-vehicle equipment control apparatus according to claim 1, wherein the controlled equipment includes a DVD player, and
the plurality of controls includes at least one of a chapter changeover switch for switching from a chapter of a DVD that is being played back by the DVD player to another chapter and a volume changeover switch for changing the volume of a chapter that is being played back by the DVD player.

11. The in-vehicle equipment control apparatus according to claim 1, wherein the controlled equipment includes different AV units, and
the plurality of controls includes a source changeover switch for switching from an operating one of the AV units to another one of the AV units.

12. The in-vehicle equipment control apparatus according to claim 1, wherein the controlled equipment includes an air conditioner, and
the plurality of controls include at least one of a temperature changeover switch for changing a temperature set in the air conditioner and an air volume changeover switch for changing an air volume set in the air conditioner.

13. The in-vehicle equipment control apparatus according to claim 1, wherein the controlled equipment includes a speech recognition unit that performs speech recognition on speech by a user input through a speech input device provided in the vehicle and performs control corresponding to the recognized speech on another component of the controlled equipment, and
the plurality of controls includes a switch for instructing the speech recognition unit to perform speech recognition on speech by the user.

14. A method for controlling controlled equipment provided in a vehicle in an in-vehicle equipment control apparatus that includes a vehicle status detection device that detects the status of the vehicle, an operation device that includes a plurality of controls that are provided on a steering wheel of the vehicle and are used to perform an operation on the controlled equipment, and a storage device, the method comprising:
when an operational instruction given via the plurality of controls is detected, outputting a signal corresponding to the operational instruction to the controlled equipment and storing the operational instruction in the storage device;
subsequently, when a first operational instruction given via one of the plurality of controls is detected, determining, on the basis of information from the vehicle status detection device, whether the vehicle is being steered; and
when it is determined that the vehicle is being steered, outputting a signal corresponding to an operational instruction that has been stored just before in the storage device to the controlled equipment.

15. The method according to claim 14, wherein, when the first operational instruction given via the one of the plurality of controls is detected, it is determined, on the basis of information from the vehicle status detection device, whether the vehicle is being steered, and when it is determined that the vehicle is not being steered, a signal corresponding to the first operational instruction is output to the controlled equipment.
